(19) United States
(12) Patent Application Publication
(10) Pub. No.: US 2005/0093389 A1
(43) Pub. Date: May 5, 2005

(54) Four pole stator assembly with two permanent magnets

(75) Inventors: Attila Simofi-Ilyes, London (CA); Andrew Lakerdas, London (CA); Martin Volkening, London (CA)

Correspondence Address: Elsa Keller, Legal Assistant;Intellectual Property Department, SIEMENS CORPORATION, 170 Wood Avenue South, Iselin, NJ, 08830, US

(73) Assignee: Siemens VDO Automotive Inc.

(21) Appl. No.: 10/816,668

(22) Filed: Apr. 2, 2004

Related U.S. Application Data
(60) Provisional application No. 60/517,444, filed on Nov. 4, 2003.

(51) Int. Cl. H02K 21/26; H02K 23/04

(52) U.S. Cl. 310/154.08; 310/154.22

(57) ABSTRACT

A stator assembly 16 for a brush-type permanent magnet DC motor includes a or body 17 having a central axis A and an annular inner wall 20 disposed about the central axis. The inner wall has at least one raised portion 21 and at least one recess 22 adjacent to the at least one raised portion. The raised portion defines a flux recovery feature. At least one permanent magnet 18 is disposed within the recess 22 such that an inside radius IRM of the magnet is substantially the same as, and concentric with, an inside radius IRF of the raised portion as measured from the central axis, with the flux recovery feature 21 and magnet 18 defining a magnetic circuit. In section, the at least one raised portion is joined with a surface defining the at least one recess by a generally S-shaped structure thereby defining a curved transition there-between. Thus, in a motor having N poles, only N/2 magnets are required.

This application is based on U.S. Provisional Application Ser. No. 60/517,444, filed on Nov. 4, 2003, and claims the benefit thereof for priority purposes.

### FIELD OF THE INVENTION

This invention relates to brush type permanent magnet DC motors for automotive applications and, more particularly, to a stator assembly employing a number of permanent magnet equal to only half of the number of poles of the motor.

### BACKGROUND OF THE INVENTION

With reference to FIGS. 1 and 2, a conventional four-pole stator assembly 10 for permanent magnet DC motor is shown generally indicated at 10. The stator assembly 10 includes a stator ring or housing 12 and four permanent magnets 14. The magnets 14 are charged after an armature assembly (not shown) is pushed into the stator assembly 10. The magnet polarity and flux paths are illustrated in FIG. 3 for a conventional four-pole permanent magnet DC motor. A better illustration of the motor magnetic circuit is shown on FIG. 6 where the whole motor was modeled and the magnetic flux lines 13 are plotted in the two dimension axis. It is clearly illustrated that when a permanent magnet 14 is assembled into the motor, the magnetic flux 13 from each magnet is split into two circuits and the magnetic flux travels through an air gap and teeth 15 of the armature assembly 19. The flux then returns through another tooth of the armature assembly and into the stator ring 12 (through the air gap again) and finally back into the same magnet at the opposite polarity side as labeled in FIG. 3. Typically, in these conventional motors, the number of permanent magnets needed is equal to the number of poles of the motor, which increases cost and weight of the motor.

Although conventional permanent magnet DC motors work well, there is a need to provide lighter weight and more cost-effective permanent magnet DC motors without compromising product integrity, (power level, efficiency, product life, etc . . . ).

### SUMMARY OF THE INVENTION

An object of the invention is to fulfill the need referred to above. In accordance with the principles of the present invention, this objective is achieved by providing a stator assembly for a brush-type permanent magnet DC motor. The stator assembly includes a stator body having a central axis and an annular inner wall disposed about the central axis. The inner wall has at least one raised portion and at least one recess adjacent to the at least one raised portion. The raised portion defines a flux recovery feature. At least one permanent magnet is disposed within the recess such that an inside radius of the magnet is substantially the same as an inside radius of the raised portion as measured from the central axis, with the flux recovery feature and magnet defining a magnetic circuit. In section, the at least one raised portion is joined with a surface defining the at least one recess by a generally S-shaped structure thereby defining a curved transition there-between. Thus, in a motor having N poles, only N/2 magnets are required.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a perspective view of a conventional four-pole stator assembly, of a permanent magnet DC motor, having four permanent magnets.

FIG. 2 is a front view of the stator assembly of FIG. 1.

FIG. 3 is a schematic view of magnet polarity and flux paths for a conventional four-pole permanent magnet DC motor.

FIG. 4 is a perspective view of a stator assembly of a permanent magnet DC motor provided in accordance with the principles of the invention.

FIG. 5 is a sectional view of the stator assembly of FIG. 4.

FIG. 6 is a view of flux paths for a conventional four-pole permanent magnet DC motor.

FIG. 7 is a view of flux paths for a permanent magnet DC motor in accordance with the invention.

### DETAILED DESCRIPTION OF THE EXEMPLARY EMBODIMENT

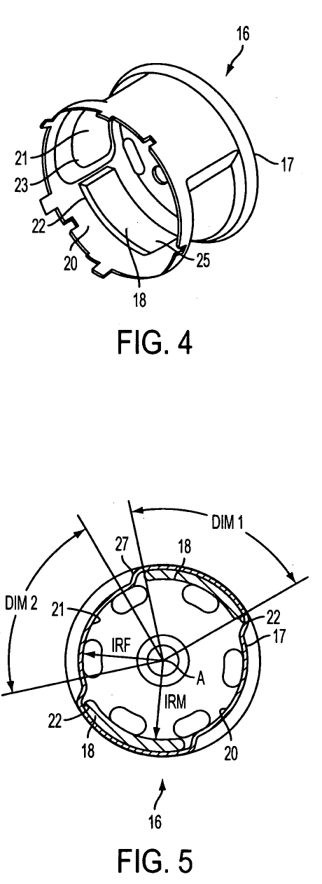

With reference to FIG. 4, a stator assembly for a permanent magnet DC motor is shown generally indicated at 16 in accordance with the invention. The stator assembly 16 can be employed in a brush-type permanent magnet DC motor, such as, for example, of the type disclosed in U.S. Pat. No. 5,977,666, the contents of which is hereby incorporated into the present specification by reference.

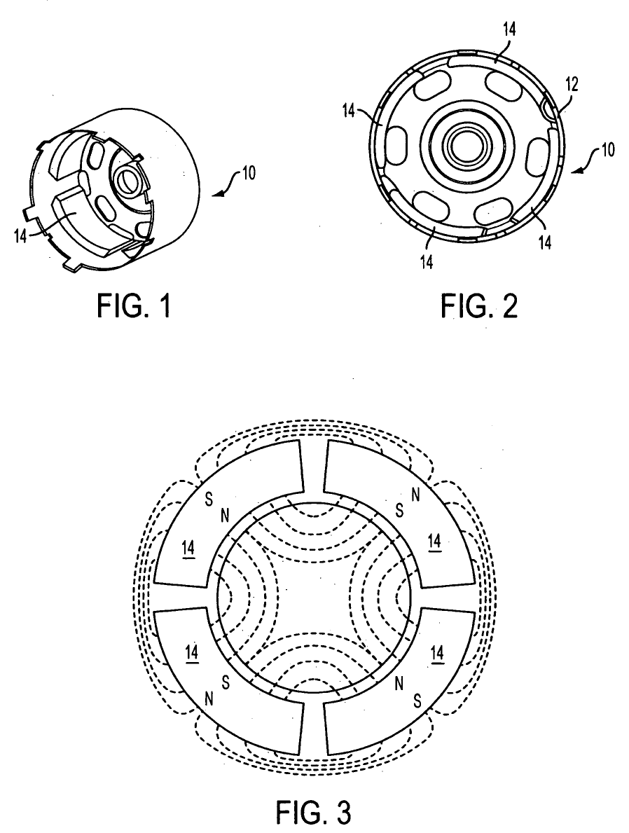

The stator assembly 16 includes a generally cylindrical, ferrous stator body 17 and a number N of magnets 18 that is half of the number of poles of the motor. In the illustrated four-pole motor, the stator assembly 16 includes only two magnets 18 instead of the four conventional magnets (FIG. 1) coupled to the stator body 17. However, the four flux paths (FIG. 3) are still completed due to a configuration of an annular inner wall 20 of the stator body 17.

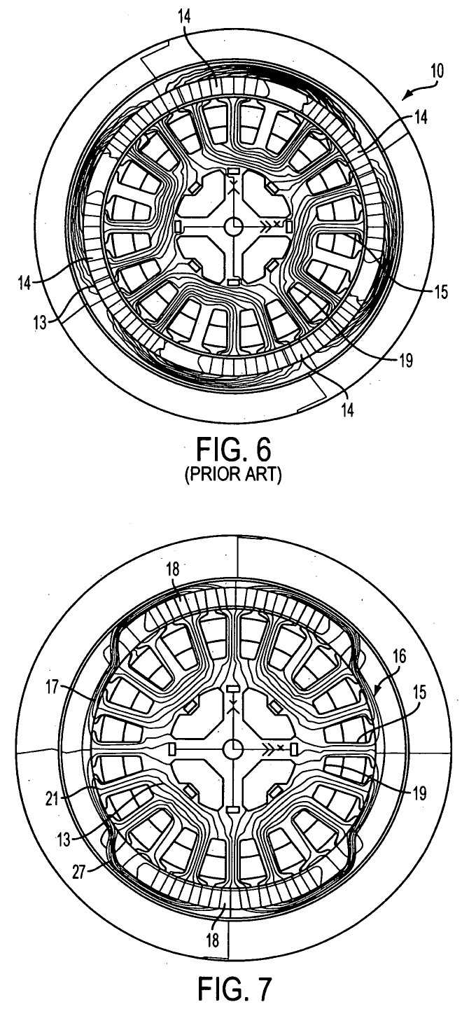

As shown in FIG. 5, the inner wall 20 includes integral raised portions, defining flux recovery features 21, and adjacent recesses 22. Each raised portion 21 is closer to a central axis A than a surface defining each recess 22. A permanent magnet 18 is disposed in each recess 22. In the embodiment, when viewed in section, a generally S-shaped structure 27 (FIG. 5) joins a surface defining the flux recovery feature 21 with a surface defining the adjacent recess 22 so as to provide a smooth, curved transition there-between. This structure facilitates the generally annular configuration of the stator assembly as shown in FIG. 4 thus, advantageously providing an overall package similar to that of the conventional stator assembly shown in FIG. 1. The S-shaped structure 27 also facilitates the flux path top close so that the flux path is substantially the same as in the conventional motor (FIGS. 3 and 6). A two dimensional illustration of the magnetic flux circuit of a Permanent DC motor of the invention is shown in FIG. 7. It is clearly illustrated that although the number of magnets 18 was reduced by half, the magnetic flux path 13 is substantially the same as in a conventional configuration as shown in FIG. 3 and FIG. 6.

The flux recovery features 21 together with the S-shaped structures 27 reduce an air gap between the stator assembly 16 and an armature 19 (FIG. 7) and, together with the magnets 18, complete a magnetic circuit. Although the flux recovery features 21 are shown to be integral with the stator body 17, it can be appreciated that the flux recovery features 21 can be separate from, and then attached to, the stator body 17.

The stator body 17 has a central axis A with the annular inner wall 20 being disposed about the axis A. Thus, as shown in FIG. 5, the magnet inside radius IRM is substantially the same as, and concentric with, the inside radius IRF of the flux recovery feature 21 as measured from the central axis A so as to reduce an air gap between the armature (not shown) and the stator assembly 16. In addition, the exposed surface 23 of the flux recovery feature 21 is of substantially the same dimensions as the exposed surface 25 of the magnet 18 (FIG. 4). Furthermore, with reference to FIG. 5, dimensions Dim 1 and Dim 2 are the same or similar angles.

The stator assembly 16 also uses an improved magnetic material for the body 17 (higher Residual Induction (Br) to improve flux and higher Intrinsic Coercive Force (Hci) to maintain resistance against demagnetization). Therefore, the motor performance is not compromised with the four-pole, two-magnet stator assembly 16.

The concept of providing a flux recovery feature 21 in place of a permanent magnet can also be employed in 2-pole, or multi pole motor application such as 6 pole, 8 pole, and so forth. The stator assembly 16 is preferably used in brush type permanent magnet DC motors for automotive applications, but can be used in any permanent magnet DC motor.

It can be appreciated that since the number of required magnets can be reduced by half the stator assembly is of reduced weight and of lower cost than conventional stator assemblies. Furthermore, since the flux path is maintained by the flux recovery features, integrity of the motor is not compromised.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A stator assembly for a brush-type permanent magnet DC motor, the stator assembly comprising:
a stator body having a central axis and an annular inner wall disposed about the central axis, the inner wall having at least one raised portion and at least one recess adjacent to the at least one raised portion, the at least one raised portion being closer to the central axis than the at least one recess, the at least one raised portion defining a flux recovery feature, and
at least one permanent magnet mounted within the recess such that an inside radius of the magnet is substantially the same as, and concentric with, an inside radius of the raised portion as measured from the central axis, with the flux recovery feature and magnet defining a magnetic circuit,
wherein, in section, the at least one raised portion is joined with a surface defining the at least one recess by a generally S-shaped structure thereby defining a curved transition there-between.

2. The stator assembly of claim 1, wherein two raised portions and two magnets are provided.

3. The stator assembly of claim 1, wherein a plurality of raised portions and a plurality of permanent magnets are provided, with the number of permanent magnets being equal to the number of raised portions and being half the number of poles of the motor.

4. The stator assembly of claim 1, wherein the at least one raised portion is integral with the stator body.

5. The stator assembly of claim 1, wherein an exposed surface of the flux recovery feature is of substantially the same dimensions as an exposed surface of the magnet.

6. A stator assembly for a brush-type permanent magnet DC motor having N number of poles, the stator assembly comprising:
a stator body having a central axis and an annular inner wall disposed about the central axis, the inner wall having at least one raised portion and at least one recess adjacent to the at least one raised portion, the at least one raised portion being closer to the central axis than at least one recess, the at least one raised portion defining a flux recovery feature, and
at least one permanent magnet mounted within the recess and defining with the flux recovery feature, a magnetic circuit,
wherein an inside radius of the magnet is substantially the same as, and concentric with, an inside radius of the raised portion as measured from the central axis,
wherein, in section, the at least one raised portion is joined with a surface defining the at least one recess by a generally S-shaped structure thereby defining a curved transition there-between,
wherein a number of raised portions is equal to a number of magnets and the number of magnets is N/2.

7. The stator assembly of claim 6, wherein two raised portions and two magnets are provided for a four-pole motor.

8. The stator assembly of claim 6, wherein the at least one raised portion is integral with the stator body.

9. The stator assembly of claim 6, wherein an exposed surface of the flux recovery feature is of substantially the same dimensions as an exposed surface of the magnet.

10. A stator assembly for a brush-type permanent magnet DC motor, the stator assembly comprising:
a stator body having a central axis and an annular inner wall disposed about the central axis, the inner wall having means for recovering flux extending toward the central axis and at least one recess adjacent to the means for recovering flux, and
at least one permanent magnet mounted within the recess such that an inside radius of the magnet is substantially the same as, and concentric with, an inside radius of the means for recovering flux as measured from the central axis, with the means for recovering flux and magnet defining a magnetic circuit,
wherein, in section, the means for recovering flux is joined with a surface defining the at least one recess by generally S-shaped structure thereby defining a curved transition there-between.

11. The stator assembly of claim 10, wherein the means for recovering flux includes two raised portions extending from the inner wall, and wherein two magnets are provided.

12. The stator assembly of claim 10, wherein the means for recovering flux includes a plurality of raised portions extending from the inner wall, and a plurality of permanent magnets are provided with one magnet being disposed between two raised portions.

13. The stator assembly of claim 10, wherein the number of permanent magnets is equal to the number of raised portions and half a number of poles of the motor.

14. The stator assembly of claim 10, wherein the means for recovering flux is integral with the stator body.

15. The stator assembly of claim 10, wherein an exposed surface of the means for recovering flux is of substantially the same dimensions as an exposed surface of the magnet.
